(19) United States
(12) Patent Application Publication
(10) Pub. No.: US 2024/0006949 A1
(43) Pub. Date: Jan. 4, 2024

(54) MAGNET WIRE

(71) Applicant: Careen, Inc., New Ulm, MN (US)

(72) Inventor: David Schauer, New Ulm, MN (US)

(21) Appl. No.: 18/340,110

(22) Filed: Jun. 23, 2023

Related U.S. Application Data
(60) Provisional application No. 63/356,638, filed on Jun. 29, 2022.

(51) Int. Cl. H02K 3/44; H02K 3/30

(52) U.S. Cl. CPC H02K 3/44; H02K 3/30

(57) ABSTRACT

An electromagnetic device includes a magnet wire assembly and a stator component. The magnet wire assembly includes a conductive wire and an insulating member overlaying the conductive wire, where the insulating member includes expanded polytetrafluoroethylene (ePTFE). The stator component includes a plurality of stator slots each having a dielectric material. The magnet wire assembly is located at each of the plurality of stator slots of the stator component to provide a magnetic circuit that includes the magnet wire assembly applied at the dielectric material of the plurality of stator slots.

### RELATED APPLICATION

This application claims priority to U.S. provisional patent application No. 63/356,638, filed on Jun. 29, 2022, the contents of which are hereby incorporated by reference.

### TECHNICAL FIELD

This disclosure generally relates to magnet wire assemblies, systems, and methods. Embodiments are disclosed herein in the context of a magnet wire in an electric motor. Other embodiments can include the magnet wire applied in other electromagnetic devices to help produce a magnetic circuit, for instance, transformers, chokes, field coils, and bobbins.

### BACKGROUND

Electric motors are used in a wide variety of applications, and the prevalence and use cases for electric motors are continually increasing. Certain such electric motor applications can involve relatively demanding and harsh environmental conditions, including the simultaneous presence of relatively high pressure, relatively high temperature, and moisture that can result in hydrolysis of components of the electric motor. Under these conditions, the insulation system of electric motors can break down and lead to electrical shorts resulting in premature electric motor failure. Established and conventional methods of protecting electric motors from hydrolysis under these conditions require complex and expensive manufacturing methods plus additional materials to encapsulate and cover the magnet wire, with the design intent of providing a barrier to protect the magnet wire. However, this barrier of materials when subjected to high pressure and high temperature tends to fail prematurely, thereby resulting in moisture contacting the magnet wires which can lead to hydrolysis and premature electric motor failure.

### SUMMARY

In general, various embodiments relating to magnet wire assemblies, systems, and methods are disclosed herein. In particular, embodiments disclosed herein include a magnet wire assembly that includes a conductive wire (e.g., copper wire) and an insulating member overlaying (directly or indirectly) the conductive wire, where the insulating member includes expanded polytetrafluoroethylene (ePTFE).

Such a magnet wire assembly having the insulating member that includes expanded polytetrafluoroethylene (ePTFE) can provide a number of useful advantages. For example, a magnet wire assembly having the insulating member that includes expanded polytetrafluoroethylene (ePTFE) can be incorporated into an electromagnetic device, such as an electric motor, and help to extend the useful life of such device, particularly in instances where such device is utilized is relatively harsh and demanding environmental conditions that include simultaneous relatively high pressure, relatively high temperature, and the presence of moisture that can cause hydrolysis. One example application of an electromagnetic device in such harsh and demanding operating conditions can be downhole applications in the oil and gas industry. The magnet wire assembly having the insulating member that includes expanded polytetrafluoroethylene (ePTFE) can provide an improved insulation structure to the electromagnetic device (e.g., electric motor) which can eliminate the need for additional, less effective materials that tend to fail. The magnet wire assembly having the insulating member that includes expanded polytetrafluoroethylene (ePTFE) can provide a basic, suitable chemical structure that can be resistant to hydrolysis even when subjected to simultaneous relatively high pressure and relatively high temperature environmental conditions. The use of the magnet wire assembly having the insulating member that includes expanded polytetrafluoroethylene (ePTFE) can simplify the electromagnetic device's structure and reduce material requirements while tuning the insulating member's chemistry, via the inclusion of the expanded polytetrafluoroethylene (ePTFE) material, as appropriate for a magnet wire assembly applied in an electromagnetic device (e.g., electric motor) to help resist hydrolysis and, thereby, help to facilitate a longer service life of the electromagnetic device.

One embodiment includes an electromagnetic device, such as an electric motor. This electromagnetic device includes a magnet wire assembly and a stator component. The magnet wire assembly includes a conductive wire and an insulating member overlaying (directly or indirectly) the conductive wire, where the insulating member includes expanded polytetrafluoroethylene (ePTFE). The stator component includes a plurality of stator slots each having a dielectric material. The magnet wire assembly is located at each of the plurality of stator slots of the stator component to provide a magnetic circuit that includes the magnet wire assembly applied at the dielectric material of the plurality of stator slots.

In a further embodiment of this device, the magnetic circuit, including the magnet wire assembly applied at the dielectric material of the plurality of start slots, is configured to provide a path to conduct flux.

In a further embodiment of this device, each of the plurality of stator slots includes the dielectric material as an insulator around at least some of a perimeter of each of the plurality of stator slots. The dielectric material can be configured to provide electrical resistance to ground. For example, each of the plurality of stator slots can include the dielectric material as an insulator around all of the perimeter of each of the plurality of stator slots.

In a further embodiment of this device, the magnet wire assembly forms continuously wound coils to define each of the plurality of stator slots. For example, the magnet wire assembly can form a concentrated winding pattern for each of the plurality of stator slots. As another example, the magnet wire assembly can form a distributed, or lap, winding pattern for each of the plurality of stator slots.

In a further embodiment of this device, the electromagnetic device is configured to operate in an operating environment having a pressure of up to 34 Kpsi and a temperature of up to 200° C.

Another embodiment includes a magnet wire assembly. This magnet wire assembly includes a conductive wire and an insulating member overlaying (directly or indirectly) the conductive wire, where the insulating member includes expanded polytetrafluoroethylene (ePTFE).

In a further embodiment of this assembly, the insulating member directly overlays and forms a sleeve around the conductive wire.

In a further embodiment of this assembly, the insulating member is configured to resist hydrolysis.

In a further embodiment of this assembly, the insulating member consists of expanded polytetrafluoroethylene (ePTFE).

In a further embodiment of this assembly, the insulating member is configured to operate in an operating environment having a pressure of up to 34 Kpsi and a temperature of up to 200° C.

The details of one or more examples are set forth in the accompanying drawings and the description below. Other features, objects, and advantages will be apparent from the description and drawings.

### BRIEF DESCRIPTION OF THE DRAWINGS

The following drawings are illustrative of particular embodiments of the present invention and therefore do not limit the scope of the invention. The drawings are intended for use in conjunction with the explanations in the following description. Embodiments of the invention will hereinafter be described in conjunction with the appended drawings, wherein like numerals denote like elements. The drawings are not necessarily to scale, though certain embodiments can include one or more components at the scale shown.

FIG. 1 is a perspective view of an embodiment of an electric motor device.

FIG. 2 is a side elevational view, of an output shaft side, of the electric motor device of FIG. 1.

FIG. 3 is a cross-sectional view, taken along line A-A of FIG. 2, showing internal components, including a magnet wire assembly, of the electric motor device of FIG. 1.

FIG. 4 is a perspective view of an embodiment of a stator component in isolation. This stator component can be an internal component of the electric motor device of FIG. 1.

FIG. 5 is a side elevational view of the stator component of FIG. 4.

FIG. 6 is a cross-sectional view, taken along line F-F of FIG. 5, showing components of the stator component of FIG. 4, including the location of the magnet wire assembly.

FIG. 7 is a cross-sectional view showing a stator slot of the stator component of FIG. 4 along with a detailed view of magnet wire assemblies included at the stator component of FIG. 4.

FIG. 8 is a perspective view of the stator component of FIG. 4 including the magnet wire assembly.

### DETAILED DESCRIPTION

The following detailed description is exemplary in nature and is not intended to limit the scope, applicability, or configuration of the invention in any way. Rather, the following description provides some practical illustrations for implementing embodiments of the present invention. Examples of constructions, materials, and/or dimensions are provided for selected elements. Those skilled in the art will recognize that many of the noted examples have a variety of suitable alternatives.

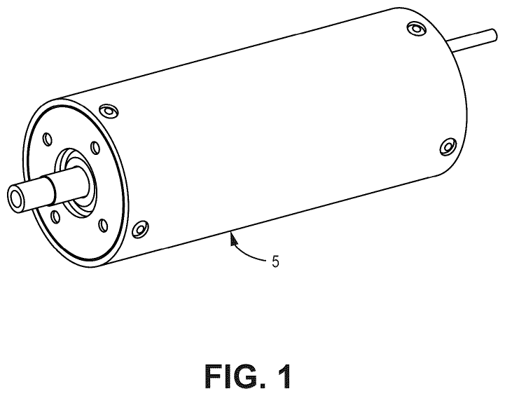

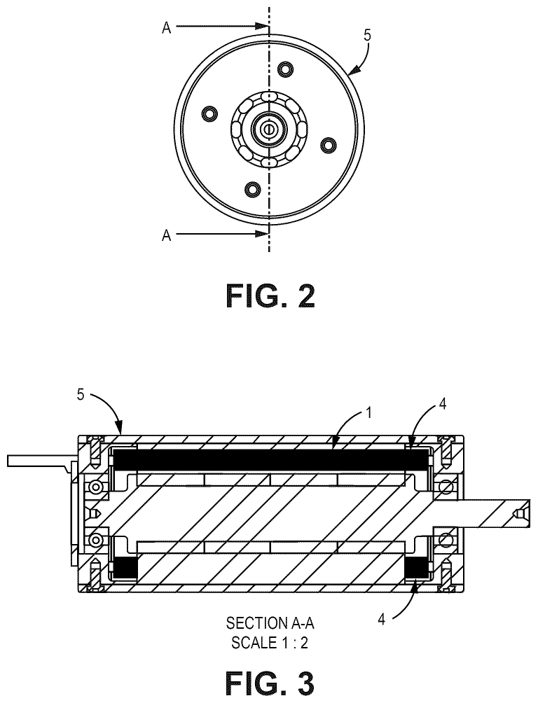

FIGS. 1-3 illustrate an exemplary embodiment of an electric motor device 5. FIG. 1 shows a perspective view of the electric motor device 5, with an output shaft of the electric motor device 5 at the left-hand side of FIG. 1. FIG. 2 shows a side elevational view, of an output shaft side, of the electric motor device 5. And, FIG. 3 shows a cross-sectional view, taken along line A-A of FIG. 2, to illustrate internal components, including a magnet wire assembly 1 and a stator component 4 of the electric motor device 5.

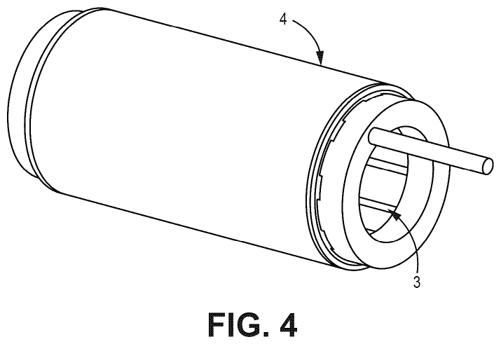

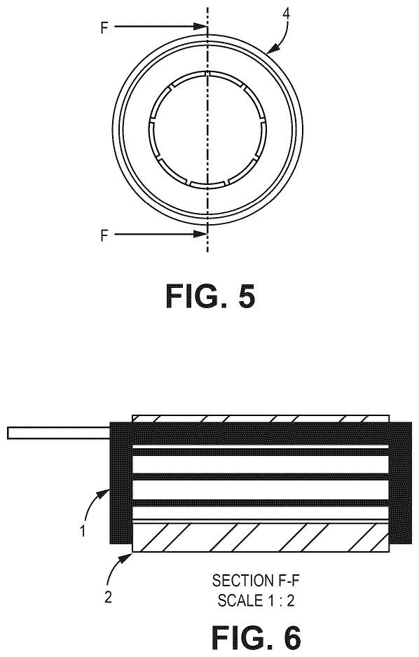

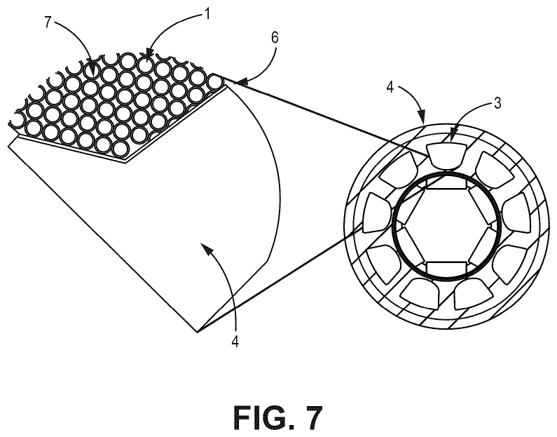

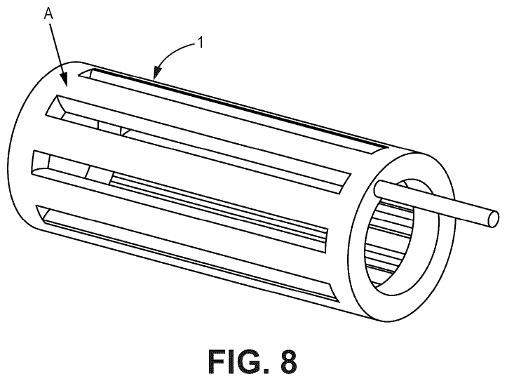

FIGS. 4-8 illustrate an exemplary embodiment of the stator component 4 that can be an internal component of the electric motor device 5. FIG. 4 shows a perspective view of the stator component 4 in isolation. FIG. 5 shows a side elevational view of the stator component 4. FIG. 6 shows a cross-sectional view, taken along line F-F of FIG. 5, with components of the stator component of 4, including the location of the magnet wire assembly 1. FIG. 7 shows a cross-sectional view of stator slots 3 of the stator component 4 along with a detailed view of magnet wire assemblies 1 included at the stator component 4. As seen at FIG. 7, the magnet wire assembly 1 includes an insulating member 7 and is adjacent a dielectric material 6. And, FIG. 8 is a perspective view of the stator component 4, including the magnet wire assembly 1.

Expanded polytetrafluoroethylene (ePTFE) has a microstructure defined by fibrils (e.g., thread-like elements) and nodes (e.g., particles from which fibrils emerge). ePTFE is described in detail in U.S. Pat. No. 5,374,473. ePTFE, when applied to the outer diameter of a solid conductive (e.g., copper) wire acts as an insulator which can be used as a magnet wire in the electric motor device 5 while enabling enhanced performance qualities optimized for operation in high pressure, high temperature and in operating environments subject to hydrolysis. This disclosure describes embodiments related to the present inventive discovery that, under these relatively harsh conditions, the performance qualities of ePTFE can enable the electric motor device 5 to simultaneously withstand the effects of combined high temperature and high pressure while also resisting hydrolysis. The use of ePTFE as a dielectric and thermal insulator has not previously been employed as disclosed herein as a magnet wire for use in an electric motor. Other types of non-expanded polymer insulation are available but the structure of the improved electric motor incorporates the magnet wire using the unique and expanded version of an engineered fluoropolymer (ePTFE). Consideration for using an expanded fluoropolymer, such as ePTFE, as an insulator on a magnet wire in an electric motor is unique because it is not an extruded or drawn product, which is the typical type of material looked to for traditional magnet wires. Use of an expanded polymer, such as ePTFE, as magnet wire insulation installed into and used in an electric motor is notable in using the insulation also as a means to improve the motor insulation system for purposes of extending motor life under conditions susceptible to hydrolysis. Expanded polymer material, such as ePTFE, has not generally been recognized for use in improving electric motor operation as disclosed herein.

The electric motor device 5 can include the magnet wire assembly 1. The magnet wire assembly 1 can include a conductive wire (e.g., copper wire) and the insulating member 7. The insulating member 7 can overlay (directly or indirectly) the conductive wire, and the insulating member 7 can include expanded polytetrafluoroethylene (ePTFE). The ePTFE included with the insulating member of the magnet wire assembly 1 has a engineered composition to manipulate this material's structure, shape, thickness, and surface geometry paired with complementary materials to provide dielectric, thermal, and chemical performance characteristics tuned or optimized for a magnet wire assembly applied in an electromagnetic device (e.g., electric motor device 5) that can be utilized in relatively harsh and demanding operating environments.

The magnet wire assembly 1 can be located at the portion of the stationary field of the electric motor device 5, known as the stator component 4. The stator component 4 has a core 2 that includes shaped, laminated electrical steel of various performance grades, known as stator laminations. The lamination geometry includes features to host the placement of continuously wound coils of magnet wire commonly known as slots 3. These continuously wound coils can include the magnet wire assembly 1. In various electronic devices, including the electric motor device 5, the magnet wire assembly 1 can be located within the slots 3 having various spans from 1-2 known as a concentrated winding pattern or a span of 1->2 commonly known as a distributed or lap winding pattern.

One or more (e.g., each) stator slot 3 can be insulated around some or all of its perimeter with a dielectric material 6 as a means to provide primary electrical resistance to ground. The magnet wire assembly 1 can be applied into the slots 3 in a manner to provide a continuous magnetic circuit. It can be this magnetic circuit, including the magnet wire assembly 1 applied at the dielectric material 6 insulated slots 3, that provides a path to conduct flux and produce torque. The location of the magnet wire assembly 1 within the stator slots 3 can allow the electric motor device 5 to operate and output motive force.

### Experimental Results

Notably, the magnet wire assembly 1 having the insulating member 7 that includes expanded polytetrafluoroethylene (ePTFE) was tested in comparison to a conventional magnet wire assembly that includes a polyimide insulating member. To replicate the relatively harsh and demanding downhole tooling environment in which the electric motor can be utilized, each of (i) an electric motor having the magnet wire assembly 1 with the insulating member 7 that includes expanded polytetrafluoroethylene (ePTFE) and (ii) an electric motor having the conventional magnet wire with a polyimide insulating member was tested against oil and gas industry standard NEMA 1000, Section 3.54 at 200° C., 30 Kpsi, and 4% ambient water content. At these relatively harsh operating environmental conditions, which simulate the relatively extreme conditions in downhole tooling, the (i) electric motor having the magnet wire assembly 1 with the insulating member 7 that includes expanded polytetrafluoroethylene (ePTFE) was able to reach 34 Kpsi and 200° C. In contrast, the (ii) electric motor having the conventional magnet wire with polyimide insulating member did not reach the simulated downhole environment conditions, failing prior to onset of these conditions at 195° C. & 22 Kpsi.

Experimental results utilizing the electric motor having the magnet wire assembly 1 with the insulating member 7 that includes expanded polytetrafluoroethylene (ePTFE) have shown the following operating environmental ratings, which are significantly improved as compared to conventional magnet wires (e.g., conventional magnet wires with polyimide insulating member): temperatures up to 260° C.; pressures up to 34 Kpsi; operating environments having relatively aggressive media and fluids; relatively high aspect ratio form factor (e.g., L/D to 50:1); reliability of greater than 2,000 operating hours; shock tolerance greater than 50 g; water solubility in oil up to 4% water content; H2S resistant; and capability to survive flood events.

Various non-limiting exemplary embodiments have been described. It will be appreciated that suitable alternatives are possible without departing from the scope of the examples described herein. These and other examples are within the scope of this disclosure and ensuing claims therefrom.

What is claimed is:

1. An electric motor comprising:
a stator component comprising a plurality of stator slots, each stator slot of the plurality of stator slots comprising a dielectric material; and
a magnet wire assembly comprising a conductive wire and an insulating member that overlays the conductive wire, wherein the insulating member comprises expanded polytetrafluoroethylene (ePTFE), and wherein the magnet wire assembly is located at at least one of the plurality of stator slots to define a magnetic circuit that includes at least the magnet wire assembly and the dielectric material at the at least one of the plurality of stator slots.

2. The electric motor of claim 1, wherein the magnet wire assembly is located at each of the plurality of stator slots to define a magnetic circuit that includes at least the magnet wire assembly and the dielectric material at each of the plurality of stator slots.

3. The electric motor of claim 1, wherein the magnetic circuit, including the magnet wire assembly applied at the dielectric material at the at least one of the plurality of stator slots, is configured to provide a path to conduct flux.

4. The electric motor of claim 3, wherein the dielectric material is provided as an insulating member around a perimeter of the at least one of the plurality of stator slots, and wherein the dielectric material is configured to provide electrical resistance to ground.

5. The electric motor of claim 3, wherein the magnet wire assembly forms a continuously wound coil that defines the at least one of the plurality of stator slots.

6. The electric motor of claim 5, wherein the magnet wire assembly forms a concentrated winding pattern at each of the plurality of stator slots.

7. The electric motor of claim 5, wherein the magnet wire assembly forms a distributed winding pattern at each of the plurality of stator slots.

8. The electric motor of claim 1, wherein the electric motor is configured to operate in an operating environment having a pressure of up to 34 Kpsi and a temperature of up to 200° C.

9. The electric motor of claim 8, wherein the insulating member comprising ePTFE is configured to resist hydrolysis when the electric motor in the presence of an operating environment that has a pressure of up to 34 Kpsi and a temperature of up to 200° C.

10. The electric motor of claim 1, wherein the insulating member comprising ePTFE directly overlays the conductive wire such that the insulating member comprising ePTFE forms a sleeve around the conductive wire.

11. The electric motor of claim 1, wherein the insulating member consists of ePTFE.

12. The electric motor of claim 1, wherein the insulating member directly contacts the dielectric material such that the ePTFE of the insulating member directly contacts the dielectric material.

13. A magnet wire assembly comprising:
a conductive wire; and
an insulating member overlaying the conductive wire, wherein the insulating member comprises expanded polytetrafluoroethylene (ePTFE).

14. The assembly of claim 13, wherein the conductive wire comprises a copper wire.

15. The assembly of claim 13, wherein the insulating member directly overlays the conductive wire.

16. The assembly of claim 15, wherein the ePTFE directly overlays the conductive wire.

17. The assembly of claim 15, wherein the insulating member forms a sleeve around the conductive wire.

18. The assembly of claim 13, wherein the insulating member is configured to resist hydrolysis in the presence of an operating environment that has a pressure of up to 34 Kpsi and a temperature of up to 200° C.

19. The assembly of claim 13, wherein the insulating member consists of ePTFE.

20. The assembly of claim 13, wherein the magnet wire assembly, including the conductive wire and the ePTFE of the insulating member, forms a continuously wound magnetic coil.
